(19) United States
(12) Patent Application Publication
(10) Pub. No.: US 2007/0150736 A1
(43) Pub. Date: Jun. 28, 2007

(54) Token-enabled authentication for securing mobile devices

(76) Inventors: Johnas I. Cukier, Shrewsbury, MA (US); Wei Liang, Santa Cruz, CA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/317,136

(22) Filed: Dec. 22, 2005

(51) Int. Cl. H04L 9/00; H04K 1/00

(52) U.S. Cl. 713/172; 713/171; 380/270; 713/159

(57) ABSTRACT

A system and method to protect mobile devices, such as laptops, PDAs, and mobile telephones with a wearable token is presented. The method performs token-enabled authentication to enable operation of the mobile device. Short range wireless communication is used between the token and the mobile device for the purpose of authentication.

### FIELD OF THE INVENTION

This invention relates generally to securing data and devices, and more particularly to securing mobile devices, such as laptops, PDAs, cameras and mobile telephones, from unauthorized use.

### BACKGROUND OF THE INVENTION

An increased demand for sharing data, performing business transactions, and mobile computing has enabled a wide range of small, mobile devices. Mobile device are easily lost or stolen. Therefore, there is a need to enhance security of mobile devices.

The vulnerability of mobile devices can be reduced with authentication mechanisms, such as passwords, biometrics, and asymmetric-key-based authentication. However, those methods place a burden on a user and degrade the performance of the device during the authentication process.

With password authentication, the user typically provides a user name and password. Memorizing and entering the user name and password is a burden. After the user has been authenticated, data stored in the mobile device are still open to unauthorized access by anyone that gains physical control of the device after authentication. If biometric authentication is used, such as face or fingerprint authentication, then false-positive error rates are a problem. In addition, biometric authentication requires power-consuming scanners.

U.S. Patent Application No. 2003/0005300 by Noble et al. describes a method and system for protecting files stored in a laptop (client) with a token (authentication server). When the token is near the laptop a Rijndael symmetric key exchange is performed before files can be accessed.

U.S. Pat. No. 5,623,637 to Jones et al. provides a smart card to store an access password and encryption keys. To access data, the smart card is inserted in the device storing the data. The problem with that system is that the device can be compromised as soon as the card is inserted.

U.S. Pat. No. 5,889,866 to Cyras et al. describes an integrated circuit (IC) card with a stored password. When the IC card is inserted in a computer device, password authentication can be performed to enable operation of the computer device.

The following U.S. patents are also related generally to data protection: U.S. Pat. Nos. 5,012,514; 5,091,939; 5,226,080; 5,375,243; 5,657,470; 6,189,099; 6,070,240; 6,088,450; 5,757,916; 5,544,321; 5,611,050; and 5,836,010.

### SUMMARY OF THE INVENTION

A system and method protects mobile devices, such as laptops, PDAs, and mobile telephones with a wearable token.

The method performs token-enabled authentication to enable operation of the mobile device. Short range wireless communication is used between the token and the mobile device for the purpose of authentication.

### BRIEF DESCRIPTION OF THE DRAWINGS

FIG. 1 is a block diagram of a system and method for protecting a mobile device according to an embodiment of the invention;

FIG. 2 is a block diagram of a system and method for protecting a mobile device with a binding key according to an embodiment of the invention;

FIG. 3 is a diagram of an authentication exchange according to an embodiment of the invention; and

FIG. 4 is a diagram of an authentication exchange according to another embodiment of the invention;

### DETAILED DESCRIPTION OF THE PREFERRED EMBODIMENT

The authentication method described herein uses two stages: an initialization stage and a normal usage stage. The initialization stage is accomplished using one of two methods described below. The normal usage stage is a periodic authentication via a nonce that simultaneously verifies the presence of the authenticated token and prevents replay attacks.

Mobile Device, Secured Memory Device, and Token

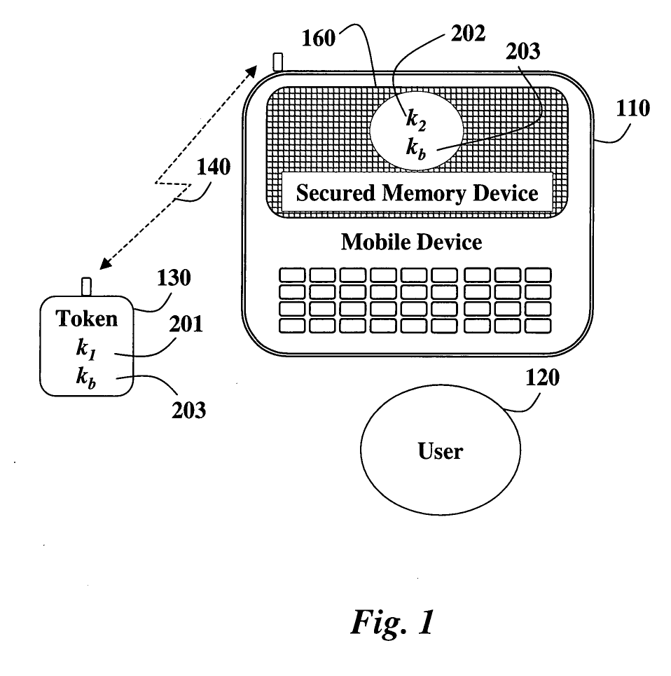

FIG. 1 shows a system and method for securing a mobile device 110, such as a PDA, laptop, camera, removable data storage device, or mobile telephone. A token 130 stores a token key k₁ 201 and a binding key k_{b} 203. A secured memory device key k₂ 202 and the binding key k_{b} 203 are stored securely within the mobile device 110 via a secured memory device 160.

In a preferred embodiment, the stored token key and secured memory device key, k₁ 201 and k₂ 202, can be encrypted, e.g., as hashed values, to avoid exposure when the secured memory device 160 or token 130 is lost, stolen, or otherwise compromised. The keys k₁ and k₂ are stored in the token and the secured memory device by a source, e.g., a retailer or a manufacturer. The binding key, k_{b} 203, is generated during the initialization stage.

Typically, the token 130 is in the physical control of the user 120. For example, the user carries the token in a pocket, or a leash attaches the token to the user.

The mobile device 110 can communicate with the token 130 via a wireless channel 140 and with the secured memory device 160. The wireless channel is a short-range communication link, e.g., the link complies with the Bluetooth specification, IEEE 802.15.1 standard, Jun. 14, 2002, incorporated herein by reference. Depending on the power level, the range for different classes of Bluetooth devices can be from 10 cm to 100 m. Thus, it can be required that the token 130 needs to be in close physical proximity to the mobile device 110 before the mobile device is enabled for operation.

Normal Usage

FIG. 1 depicts the normal use stage. The mobile device 110 detects the presence of the token 130 by a radio signal, e.g., a carrier, in the wireless channel 140. The mobile device 110 under direction from the secured memory device 160 periodically generates a nonce and expects a response from the token for authentication purposes. If the nonce response supplied by the token satisfies the required response by the secured memory device, then the mobile device is enabled for operation.

It should be understood that the secured memory device can store multiple binding keys, k_{b} 203, that can be enabled by different tokens and different users. Furthermore, it should be understood that different keys and passwords can enable access to distinct data stored in a secure memory of the mobile device, or particular applications or different hardware functions of the mobile device. In another variation, the token can enable multiple devices that store the same binding key k_{b} 203 as the token. In another variation, the token stores multiple binding keys k_{b} 203 for different secured memory devices.

Initialization Stage with Authentication Server

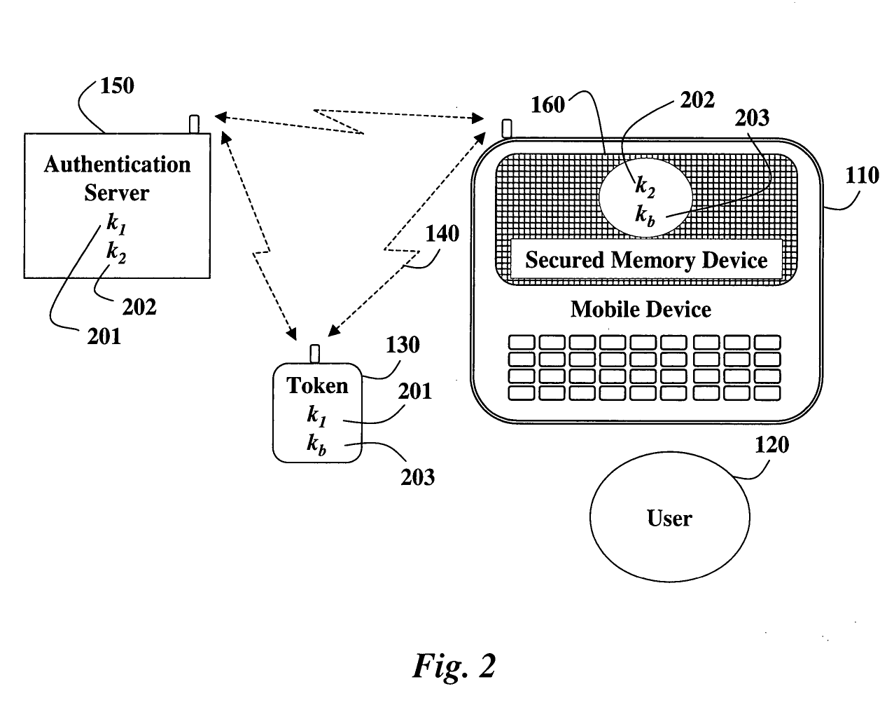

FIG. 2 shows an embodiment of the invention that uses an authentication server 150. The token 130 stores the token key k₁ 201, and the secured memory device 160 within a mobile device 110 stores the secured memory device key k₂ 202. When the user 120 acquires the token and the secured memory device, the user can bind the devices 130 and 160 from the respective sources via an authentication server 150. The authentication server 150 accesses the token 130 via its token key k₁ 201, and accesses the secured memory device 160 via its secured memory device key k₂ 202 in order to place a binding key k_{b} 203 in the token 130 and secured memory device 160. The result is the token 130 and secured memory device 160 are now bound to each other without intervention by a user 120.

The binding key k_{b} 203 is stored in the token and the secured memory device for the normal usage stage. The binding key is stored in the token and the secured memory device device 110 until the binding key is removed through an unbinding of the token and secured memory device device. Unbinding can occur for the following reasons: access privileges have changed, either the token or the mobile device has changed ownership, or either the token or the device has been lost or stolen.

After the token or tokens are bound to the secured memory device, the secured memory device refuses any further change in bindings unless at least one of the original legitimate tokens is present. This prevents a stolen secured memory device from binding with any token.

Initialization Stage with Authentication Server Key Exchange

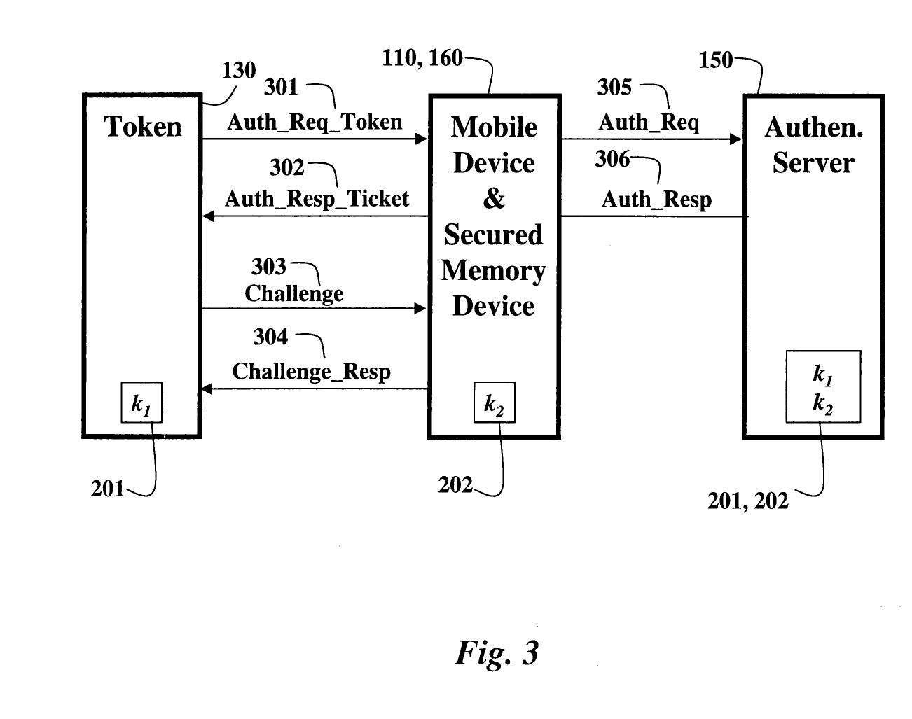

The secured memory device and token can ‘bind’ as shown in FIG. 3. The token 130 sends a first authentication request message 301, Auth_Req_Token, to the mobile device 110 for the initial authentication. The message Auth_Req_Token is defined as:
(Auth_Req_Token={IDₜ, AuthReq}),
where IDₜ is an identification of the token, and AuthReq indicates that this message is for the initial authentication with the mobile device.

In response to receiving the authentication request message Auth_Req_Token, the mobile device 110 appends the secured memory device's identification, IDₛ, to the message generating Auth_Req 305, which is defined as:
(Auth_Req={IDₜ, IDₛ, AuthReq}),
where IDₛ is an identification of the secured memory device 160 of the mobile device 110. This message is forwarded to the authentication server 150. The authentication server looks up both IDs and responds with an authentication response message, Auth_Resp 306. The message structure for Auth_Resp is defined as:
(Auth_Resp={IDₛ, k_{b}, {IDₜ, k_{b}}^{k}^{₁}}^{k}^{₂}),
where this message and message portions are encrypted with both the token and the secured memory device keys k₁ and k₂. IDₜ is an identification of the token, IDₛ is an identification of the secured memory device, k₁ is the token device key 201, k₂ is the secured memory device key 202, and k_{b} is the binding key 203 that binds the token and secured memory device. The secured memory device decrypts its portion of the message, Auth_Resp, stores the binding key k_{b} 203, and forwards the remaining part of the message, Auth_Resp_Ticket 302, to the token. Auth_Resp_Ticket is defined as follows:
(Auth_Resp_Ticket={IDₜ, k_{b}}^{k}^{₁}).
The token decrypts this message and stores the binding key, k_{b} 203, as well. The token then sends a challenge message, Challenge 303, using a nonce. The nonce is generated by the token using a random number. The random number R is encrypted using the binding key, k_{b} 203, and is formulated as follows:
(Challenge={R}^{k}^{_{b}}).
The secured memory device responds to the challenge, Challenge_Resp 304, by decrypting the nonce, calculating the nonce response, and encrypting the nonce response with the binding key, k_{b} 203 as follows:
(Challenge_Resp={R−1}^{k}^{_{b}}).
The token decrypts the nonce response and if the nonce response satisfies the token's requirements, then the secured memory device and token are bound via the binding key, k_{b} 203.

Initialization Stage without Authentication Server

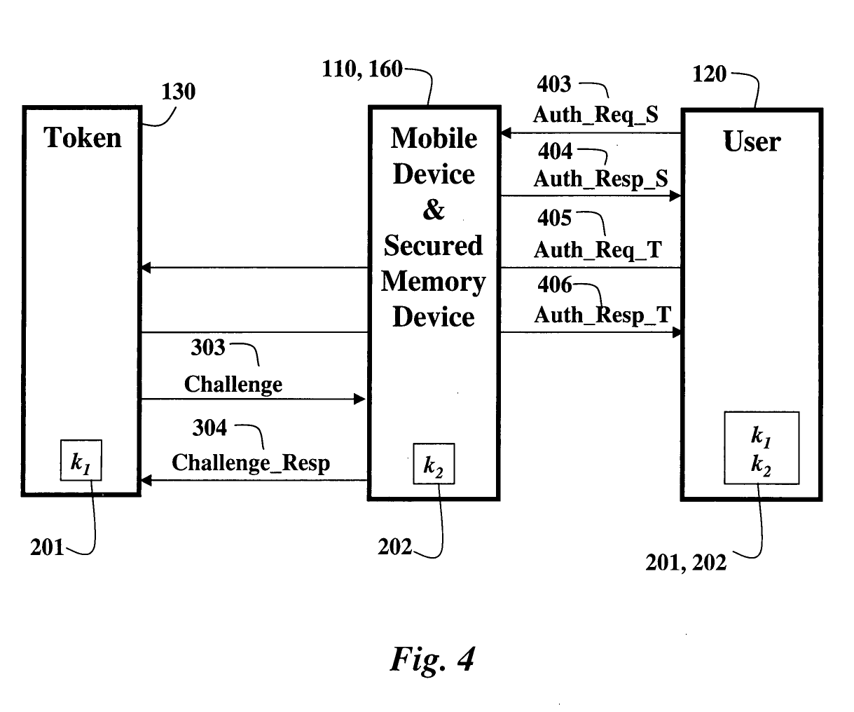

FIG. 4 shows an alternative embodiment of the invention that involves the user 120. The token 130 stores a token key k₁ 201, and the secured memory device 160 within the mobile device 110 stores a secured memory device key k₂ 202. Both devices also store a default binding key k_{b}_{₀}. When the user acquires the token and the secured memory device, the user also acquires a encryption of the keys 201-202 from the respective sources. The user 120 accesses the token 130 via a message embedded with the token key k₁ 201, and accesses the secured memory device 160 via a message embedded with the secure memory device key k₂ 202 in order to store the binding key k_{b} 203 in the token 130 and secured memory device 160. The result is the token 130 and secured memory device 160 are now bound to each other.

The binding key k_{b} 203 is stored in the token and the secured memory device for the normal usage stage. The binding key is stored in the token and the mobile device until the binding key is removed through an unbinding of the token and mobile device. Unbinding occurs for the following reasons: access privileges have changed, either the token or the mobile device has changed ownership, or either the token or the device has been lost or stolen.

Initialization Stage without Authentication Server Key Exchange

The secured memory device and token also can ‘bind’ as shown in FIG. 4. The user 120, sends a first authentication request message, Auth_Req_S 403, to the secured memory device 160 for the initial authentication. Any communications device can be used to send this message. The message Auth_Req_S is defined as:
a. (Auth_Req_S={k₂}^{k}^{₂}),
where k₂ is the secured memory device key 201 of the secured memory device 160 indicating a request for the user's initial authentication with the secured memory device.

In response to receiving the authentication request message, Auth_Req_S, the secured memory device 160 sends an authentication response message, Auth_Resp_S 404. The message Auth_Resp_S is defined as:
(Auth_Resp_S={AuthResp}),
where AuthResp indicates that authentication was successful.

The user 120 submits an authentication request to the token 130 via the secured memory device 160 by sending the Auth_Req_T 405 defined as:
(Auth_Req_T={k₁}^{k}^{₁}),
where k₁ is the token key 201 of the token 130 indicating a request for the user's initial authentication with the token.

In response to receiving the authentication request message, Auth_Req_T, the token device 130 sends an authentication response message, Auth_Resp_T 406. The message Auth_Resp_T is defined as:
(Auth_Resp_T={AuthResp}),
where AuthResp indicates that authentication was successful.

The secured memory device then sends a challenge message, Challenge 401, using a nonce which also becomes the new binding key, k_{b}. The nonce is generated by the secure memory device using a random number and encrypted using the default binding key, k_{b}_{₀}, and is formulated as follows:
(Challenge={k_{b}}^{k}^{_{b}}₀).

The token device responds to the challenge, Challenge_Resp 402, by decrypting the nonce, calculating the nonce response, and encrypting it with the default binding key, k_{b}_{₀}, as follows:
(Challenge_Resp={k_{b}−1}^{k}^{_{b}}₀).

The secured memory device decrypts the nonce response. If the nonce response satisfies the secured memory device's requirements, then the secured memory device and token are bound via the new binding key, k_{b}. Challenge exchanges used for normal usage immediately follow at this point.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A computer implemented method for securely acquiring a binding key for a token and a secured memory device, comprising the steps of:
storing a token key in a token;
storing a secured memory device key in a secured memory device of a mobile device;
accessing, by an authentication server, the token key and the secured memory device key to generate a binding key; and
storing the binding key in the token and the secured memory device.

2. The method of claim 1, further comprising the steps of:
sending, from the token device to the mobile device, a first authentication request message, Auth_Req_Token, in which the first authentication request message is defined as:
(Auth_Req_Token={IDₜ, AuthReq}),
where IDₜ is an identification of the token, and AuthReq indicates that the first authentication request message is for initial authentication with the mobile device;
generating, in the mobile device and in response to receiving the first authentication request message, a second authentication request message, Auth_Req, in which the second authentication request message is defined as:
(Auth_Req={IDₜ, IDₛ, AuthReq}),
where IDₛ is an identification of the secured memory device of the mobile device;
sending the second authentication request message to an authentication server;
responding with a first authentication response message, Auth_Resp, defined as:
(Auth_Resp=55 IDₛ, k_{b}, {IDₜ, k_{b}}^{k}^{₁}}^{k}^{₂}),
where the first authentication response message is encrypted with the secured memory device key k₂, and the identification of the token and the binding key k_{b} are encrypted with the token key k₁ and the secured memory device key k₂;
decrypting, by the secured memory device, the first authentication response message;
storing the binding key k_{b} in the secured memory device;
forwarding, to the token device, an second authentication response message, Auth_Resp_Ticket, in which the second authentication response message is defined as:
(Auth_Resp_Ticket={IDₜ, k_{b}}^{k}^{₁});
decrypting, by the token device, the second authentication response ticket; and
storing the binding key k_{b} in the token device.

3. A computer implemented method for securely acquiring a binding key for a token and a secured memory device, comprising the steps of:
storing a token key in a token;
storing a secured memory device key in a secured memory device of a mobile device;
accessing, by a user, the token device and the secured memory device using the token key and the secured memory device key;
generating, in the secured memory device, a binding key;
storing the binding key in the secured memory device;
storing the binding key in the token and the secured memory device.

4. The method of claim 1, further comprising the steps of:
sending, from a mobile device to a secured memory device, a first authentication request message, Auth_Req_S, in which the first authentication message is defined as:
(Auth_Req_S={k₂}^{k}^{₂}),
where k₂ is a secured memory device key;
generating, in the mobile device and in response to receiving the first authentication request message, a first authentication response message, Auth_Resp_S, in which the first authentication response message is defined as:
(Auth_Resp_S={AuthResp}),
where AuthResp indicates that authentication was successful;
sending, from a mobile device to a token device, a second authentication request message, Auth_Req_T, in which the second authentication message is defined as:
(Auth_Req_T={k₁}^{k}^{₁}),
where k₁ is a token device key;
generating, in the token device and in response to receiving the second authentication request message, a second authentication response message, Auth_Resp_T, in which the second authentication response message is defined as:
(Auth_Resp_T={AuthResp}),
where AuthResp indicates that authentication was successful;
generating, in the secured memory device, a binding key;
storing the binding key in the secured memory device;
encrypting the binding key with a default binding key;
sending the encrypted binding key to the token device;
decrypting, with the default binding key, the encrypted binding key to retrieve the binding key; and
storing the binding key in the token device.

5. A system for securely binding a token device and a secured memory device, comprising:
a token storing a token device key; and
a secured memory device storing a secured memory device key.

6. The system of claim 5, further comprising:
an authentication server.
